(19) United States
(12) Patent Application Publication
(10) Pub. No.: US 2012/0063007 A1
(43) Pub. Date: Mar. 15, 2012

(54) LENS BARREL, IMAGING DEVICE AND INFORMATION TERMINAL

(75) Inventors: Hiroaki IMAGAWA, Tokyo (JP); Mitsuhiko OKUNO, Tokyo (JP)

(73) Assignee: OLYMPUS CORPORATION, Tokyo (JP)

(21) Appl. No.: 13/229,795

(22) Filed: Sep. 12, 2011

(30) Foreign Application Priority Data
Sep. 15, 2010 (JP) 2010-206312
Sep. 15, 2010 (JP) 2010-206313

(51) Int. Cl. G02B 7/04

(52) U.S. Cl. 359/700; 359/699

(57) ABSTRACT

A lens barrel includes : a first zoom lens; a second zoom lens; a first zoom lens supporting barrel that supports the first zoom lens; a second zoom lens supporting barrel that supports the second zoom lens; a moving member that moves the first zoom lens supporting barrel and the second zoom lens supporting barrel in an optical axis direction of the first and second zoom lens supporting barrels; a first projected section that is provided in one of the first zoom lens supporting barrel and the moving member to cross the optical axis direction and engages with a first groove section provided in the other; and a second projected section that is provided in one of the second zoom lens supporting barrel and the moving member to cross the optical axis direction and engages with a second groove section provided in the other.

### Cross Reference to related applications

This application claims benefit of Japanese Application No. 2010-206312 filed on Sep. 15, 2010, and Japanese Application No. 2010-206313 filed on Sep. 15, 2010, and the contents of which are incorporated by this reference.

### BACKGROUND OF THE INVENTION

1. Field of the Invention

The present invention relates to a lens barrel including plural zoom lens supporting barrel movable in an optical axis direction, an imaging device including this lens barrel, and an information terminal.

2. Description of the Related Art

In recent years, there is a need for an imaging device that is reduced in size and weight and improved in performance for incorporation into a cellular phone and the like. As a technique for satisfying the need, for example, Patent Document 1 (Japanese Laid-open Patent Publication No. 2005-10281) discloses a technique concerning an imaging device incorporating a compact zoom mechanism including a bent optical system with a reduced thickness.

In the technique disclosed in Patent Document 1, the zoom mechanism includes a shaft-like cam member having a cam section formed on the outer circumferential surface thereof for determining the position of a moving lens barrel, and a motor that rotates this cam member. The cam member is arranged such that apart of the cam member is adjacent to a side of a reflection optical element in at least an axis direction.

For example, Patent Document 2 (Japanese Laid-open Patent Publication No. 2009-211102) discloses a drop prevention mechanism for preventing a cam pin from dropping from a cam groove when external force is applied.

In a technique disclosed in Patent Document 2, in a cam mechanism, an auxiliary cam groove wider than the cam groove is provided in parallel to the cam groove . Separately from the cam pin and the cam groove engaging with each other, a cam pin for drop prevention and the auxiliary cam groove engage with each other.

In the technique of Patent Document 2, plane sections serving as striking portions in an optical axis direction are provided on a feed-out side and a feed-in side of the auxiliary cam groove. The cam pin for drop prevention comes into contact with the striking portions of the auxiliary cam groove to prevent the cam pin from dropping from the cam groove.

### SUMMARY OF THE INVENTION

A lens barrel according to an aspect of the present invention includes: a first zoom lens; a second zoom lens; a first zoom lens supporting barrel that supports the first zoom lens; a second zoom lens supporting barrel that supports the second zoom lens; a moving member that moves the first zoom lens supporting barrel and the second zoom lens supporting barrel in an optical axis direction of the first and second zoom lens supporting barrel; a first projected section that is provided in one of the first zoom lens supporting barrel and the moving member to cross the optical axis direction and engages with a first groove section provided in the other; and a second projected section that is provided in one of the second zoom lens supporting barrel and the moving member to cross the optical axis direction and engages with a second groove section provided in the other.

An imaging device according to another aspect of the present invention includes : the lens barrel according to the present invention; an image pickup device that receives exit light from the lens barrel and outputs an imaging signal; and a control unit that performs at least zoom lens control for the lens barrel.

An information terminal according to another aspect of the present invention includes: the imaging device according to the present invention; and a control unit that controls the imaging device.

### BRIEF DESCRIPTION OF THE DRAWINGS

FIG. 1 is a front view showing a schematic configuration of an imaging device according to one embodiment of the present invention;

FIG. 2 is a sectional view showing a schematic configuration of the inside of the imaging device according to one embodiment of the present invention;

FIG. 3 is a disassembled perspective view showing a schematic configuration of the imaging device according to one embodiment of the present invention;

FIG. 4 is a perspective view showing a schematic configuration of the imaging device from which a bent optical system is removed according to one embodiment of the present invention;

FIG. 5 is a front view showing a schematic configuration of an imaging device according to another embodiment of the present invention;

FIG. 6 is a sectional view showing a schematic configuration of the inside of the imaging device according to another embodiment of the present invention;

FIG. 7 is an enlarged view of an A part shown in FIG. 6;

FIG. 8A is a front view showing an information terminal according to yet another embodiment of the present invention;

FIG. 8B is a rear view showing the information terminal according to yet another embodiment of the present invention; and

FIG. 9 is a schematic block diagram showing a control configuration of the information terminal according to yet another embodiment of the present invention.

### DETAILED DESCRIPTION OF THE PREFERRED EMBODIMENTS

Lens barrels and imaging devices according to a preferred embodiment of the present invention are explained below with reference to the drawings.

### One Embodiment

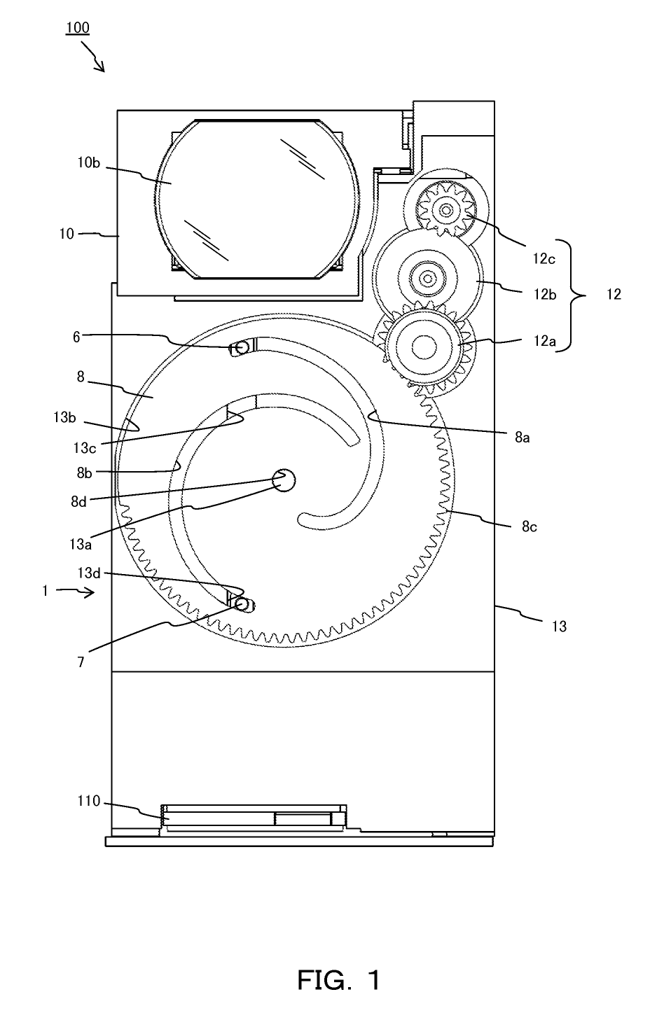

As shown in FIGS. 1 to 4, an imaging device 100 includes a lens barrel 1, an image pickup device substrate 110 including an image pickup device 111 that receives exit light from this lens barrel 1 and outputs an imaging signal, and a control unit 120 that performs at least zoom lens control for the lens barrel 1. The imaging device 100 is arranged in, for example, a communication apparatus such as a cellular phone or other electronic apparatuses.

The lens barrel 1 includes a first zoom lens 2, second zoom lenses 3 (3a and 3b), a first zoom lens supporting barrel 4, a second zoom lens supporting barrel 5, a first cam pin (an example of a first projected section) 6, a second cam pin (an example of a second projected section) 7, a cam plate member (an example of a moving member) 8, an imaging lens 9, a bent optical system 10 including a prism (an example of a bending optical element) 10a and an incident lens 10b, a driving unit 11, a gear train 12 forming a power transmitting unit, a fixed barrel 13, a guide shaft 14, a rotation stop shaft 15, and a spacer 16.

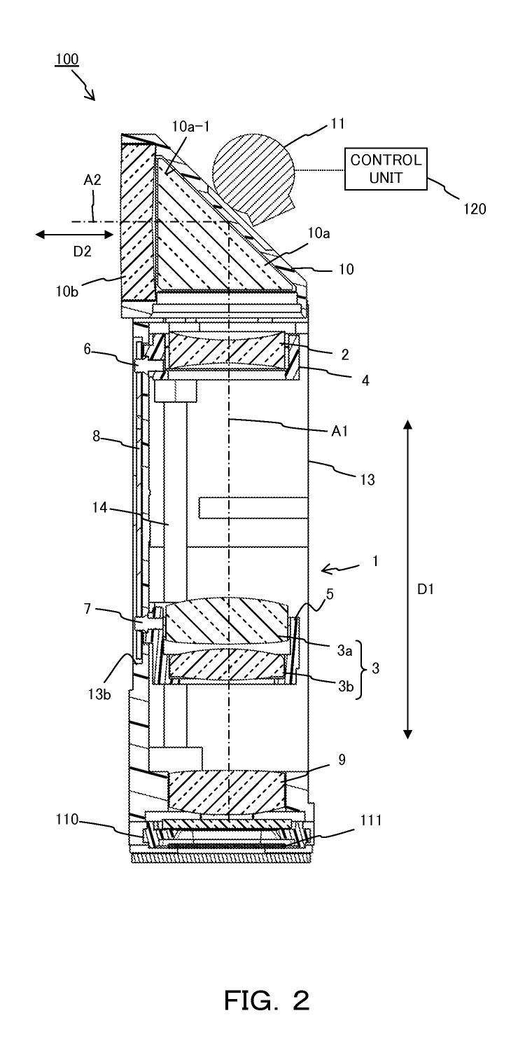

As shown in FIG. 2, the first zoom lens 2 is supported by the first zoom lens supporting barrel 4. In this embodiment, the two arranged second zoom lenses 3 (3a and 3b) are supported by the second zoom lens supporting barrel 5 and are located further on an exit side (a lower part in the figure) in an optical axis direction D1 than the first zoom lens 2.

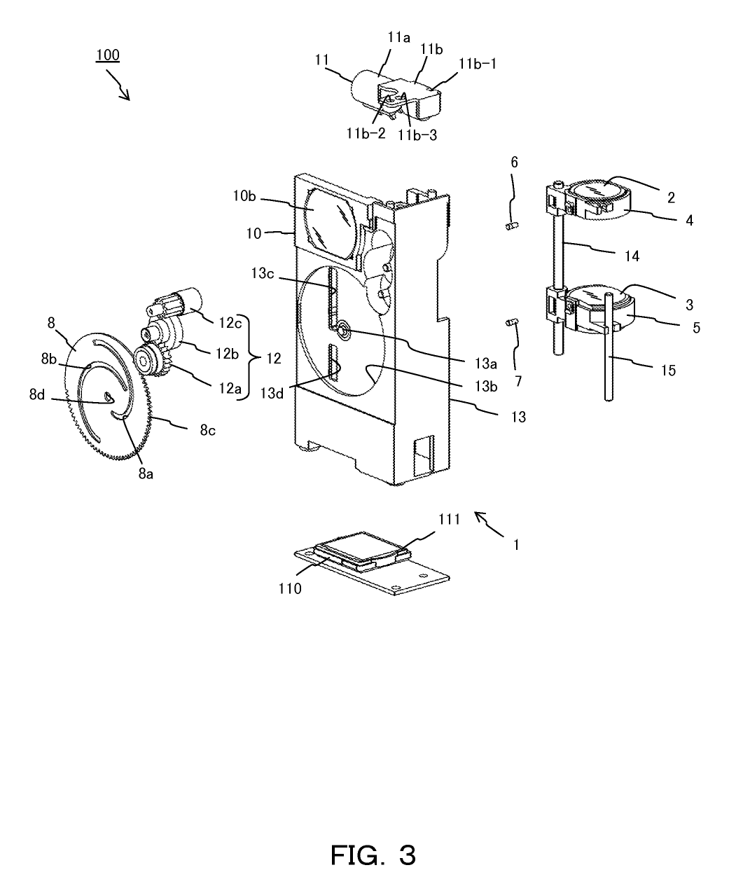

As shown in FIGS. 2 and 3, the first zoom lens supporting barrel 4 and the second zoom lens supporting barrel 5 are supported by the guide shaft 14, which extends in the optical axis direction D1 (an optical axis Al), to be movable independently from each other. As shown in FIG. 3, the second zoom lens supporting barrel 5 moves in the optical axis direction D1 (the optical axis A1) along the guide shaft 14 and the rotation stop shaft 15 arranged in parallel to this guide shaft 14. In the guide shaft 14, a not-shown compression spring (an example of an urging mechanism) that urges the first zoom lens supporting barrel 4 and the second zoom lens supporting barrel 5 in directions away from each other is provided.

As shown in FIGS. 1 to 4, the first cam pin 6 is provided in the first zoom lens supporting barrel 4 to be orthogonal to (or to cross) the optical axis direction D1. The second cam pin 7 is provided in the second zoom lens supporting barrel 5 to be orthogonal to (or to cross) the optical axis direction D1.

In this embodiment, the first cam pin 6 and the second cam pin 7 are members independent from the first zoom lens supporting barrel 4 and the second zoom lens supporting barrel 5 and fixed to the first zoom lens supporting barrel 4 and the second zoom lens supporting barrel 5. However, the first cam pin 6 and the second cam pin 7 may be cam pins integrally formed with the first zoom lens supporting barrel 4 and the second zoom lens supporting barrel 5.

The cam plate member 8 (an example of a moving member) assumes a disc shape having teeth 8c that mesh with one gear 12a of the gear train 12 formed in the outer circumference thereof. A center through-hole 8d is formed in the center of the cam plate member 8. The cam plate member 8 is pivotably supported in the center through-hole 8d by a cam plate pivoting shaft pin 13a provided in the fixed barrel 13. This cam plate pivoting shaft pin 13a is orthogonal to (or crosses) the optical axis direction D1 and functions as a pivoting shaft of the cam plate member 8.

In this embodiment, since the cam plate member 8 does not pivot 360 degrees, the teeth 8c are formed only in a part of the outer circumference of the cam plate member 8. The material of the cam plate member 8 is not specifically limited. However, the lens barrel 1 and the imaging device 100 can be thin by using a thin plate for the cam plate member 8. Therefore, in particular, when the cam plate member 8 is made thin, it is desirable to secure strength using metal from the viewpoint of drop resistance or the like of the imaging device 100.

In the cam plate member 8, a first groove section 8a that engages with the first cam pin 6 and a second groove section 8b that engages with the second cam pin 7 are formed in the circumferential direction of the cam plate member 8 to pierce through the cam plate member 8 in the thickness direction in this embodiment. The first groove section 8a and the second groove section 8b are formed independently from each other such that distances from the center through-hole 8d to the first groove section 8a and the second groove section 8b increase toward one side in the circumferential direction and decrease toward the other side in the circumferential direction.

Therefore, engaging positions of the first groove section 8a and the second groove section 8b with the first cam pin 6 and the second cam pin 7 change as the cam plate member 8 pivots. The first zoom lens supporting barrel 4 and the second zoom lens supporting barrel 5 in which the first cam pin 6 and the second cam pin 7 are provided to move close to or away in the optical axis direction D1.

The first cam pin 6 and the second cam pin 7 are inserted into the first groove section 8a and the second groove section 8b of the cam plate member 8 piercing through cam pin pierce-through grooves 13c and 13d provided in the fixed barrel 13 and extending in the optical axis direction D1.

In this embodiment, when the cam plate member 8 rotates clockwise in front view of FIG. 1, as shown in FIG. 1, the first cam pin 6 and the second cam pin 7 move away from the center through-hole 8d (the cam plate pivoting shaft pin 13a) along the first groove section 8a and the second groove section 8b.

The first zoom lens supporting barrel 4 and the second zoom lens supporting barrel 5 move to a wide angle side.

On the other hand, when the cam plate member 8 rotates counterclockwise in front view of FIG. 1, the first cam pin 6 and the second cam pin 7 move close to the center through-hole 8d (the cam plate pivoting shaft pin 13a) along the first groove section 8a and the second groove section 8b. The first zoom lens supporting barrel 4 and the second zoom lens supporting barrel 5 move to a telescopic side.

In this embodiment, the first groove section 8a and the second groove section 8b are provided in the cam plate member 8. The first cam pin 6 and the second cam pin 7 are respectively provided in the first zoom lens supporting barrel 4 and the second zoom lens supporting barrel 5. Therefore, as explained later, it is possible to realize a further reduction in size of the lens barrel 1 and the imaging device 100. However, a first projected section and a second projected section may be provided in, for example, portions of the cam plate member 8 where the groove section 8a and the groove section 8b are provided. A first groove section and a second groove section that engage with the first projected section and the second projected section may be respectively provided in the first zoom lens supporting barrel 4 and the second zoom lens supporting barrel 5.

As shown in FIG. 2, the imaging lens 9 is located further on the exit side in the optical axis direction D1 than the first zoom lens 2 and the second zoom lenses 3. Specifically, the imaging lens 9 is located at the lower end of the lens barrel 1 and supported by the fixed barrel 13.

The prism 10a of the bent optical system 10 is located further on the incident side in the optical axis direction D1 than the first zoom lens 2 and the second zoom lenses 3 and bends incident light (an incident optical axis A2) at a right angle.

The incident lens 10b is located on the incident side in an incident optical axis direction D2 of the prism 10a.

The cam plate member 8 is housed in a cam plate housing recess 13b of the fixed barrel 13 from the outer side. The cam plate member 8 is provided further in an incident side direction (the left side in the figure) in the incident optical axis direction D2 of the incident lens 10b than the first zoom lens supporting barrel 4 and the second zoom lens supporting barrel 5.

The incident lens 10b projects to the incident side in the incident optical axis direction D2 from the fixed barrel 13. The cam plate member 8 is provided such that the cam plate pivoting shaft pin 13a serving as the pivoting center is orthogonal to the optical axis direction D1 as explained above. The cam plate member 8 is arranged in parallel to the optical axis direction D1. The cam plate member 8 is provided in a position where the cam plate member 8 does not project further in the incident side direction of the incident optical axis direction D2 than the incident surface of the incident lens 10b.

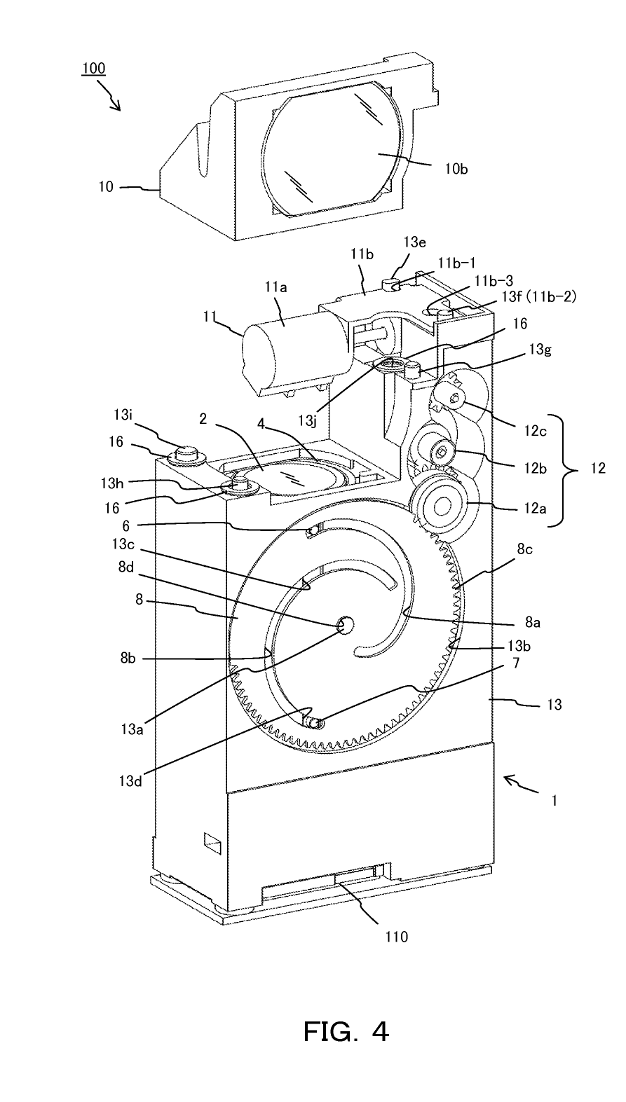

As shown in FIGS. 3 and 4, the driving unit 11 includes a motor 11a functioning as a driving source and a flange section 11b formed in a substantial L shape (viewed from the upper side of the figure) in plan view. As shown in FIG. 2, the motor 11a as at least a part of the driving unit 11 is located on the back side of a reflection surface 10a-1 of the prism 10a.

The motor 11a can pivot the gear train 12 (i.e., rotate the gear train 12 in both directions). The power of the motor 11a is transmitted to the cam plate member 8 by the gear train 12 including plural gears 12c, 12b, and 12a. The gears 12c, 12b, and 12a of the gear train 12 are pivotably engaged with the fixed barrel 13. As explained above, the gear 12a on the cam plate member 8 side meshes with the teeth 8c of the cam plate member 8 and pivots the cam plate member 8.

The control unit 120 performs driving control for the motor 11a to control the movement of the first zoom lens supporting barrel 4 and the second zoom lens supporting barrel 5, i.e., zoom lens control. The control unit 120 may perform other control such as processing of an imaging signal output from the image pickup device 111 other than the zoom lens control for the lens barrel 1.

In the flange section 11b, a cutout 11b-1 formed in a substantial U shape is formed at the peripheral edge. In the flange section 11b, two through-holes 11b-2 and 11b-3 are formed in the thickness direction, which is the optical axis direction D1.

As shown in FIG. 4, pins 13e and 13f projecting upward from the fixed barrel 13 are inserted into the cutout 11b-1 and one through-hole 11b-2 of the flange section 11b in order to position the driving unit 11 and stop of the rotation of the driving unit 11.

A not-shown screw for fixing the driving unit 11 to the fixed barrel 13 is inserted into the other through-hole 11b-3 of the flange section 11b.

In the fixed barrel 13, pins 13g, 13h, and 13i are provided.

The pins 13g, 13h, and 13i of the fixed barrel 13 are inserted into a not-shown insertion hole formed at the bottom of the bent optical system 10. In this way, the bent optical system 10 is positioned with respect to the fixed barrel 13 and stopped rotating.

In three places in total of the two pins 13g and 13h and an insertion hole 13j of the fixed barrel 13, ring-like spacers 16 are stacked. The bent optical system 10 is subjected to tilt adjustment (an example of position adjustment) by adjusting the number of the spacers 16.

As explained above, the prism 10a is arranged to be adjustable in position with respect to the fixed barrel 13. The gear train 12 and the driving unit 11 are fixed to the fixed barrel 13. Therefore, a positional shift that occurs when gears associated with each other are respectively provided on the bent optical system 10 side and the fixed barrel 13 side as in the past, i.e., a positional shift of the gear train 12 and the driving unit 11 due to the tilt adjustment of the prism 10a is prevented.

As shown in FIGS. 2 and 3, the image pickup device substrate 110 is fixed to, for example, a bottom plate of the fixed barrel 13 on the exit side in the optical axis direction L1 of the imaging lens 9. The image pickup device 111 of the image pickup device substrate 110 receives exit light from the lens barrel 1, i.e., exit light from the imaging lens 9 and outputs an imaging signal. This imaging signal is sent to, for example, the control unit 120 shown in FIG. 2.

The zoom lens control performed using the imaging device 100 is explained. However, redundant explanation is omitted as appropriate.

First, the movement of the first zoom lens supporting barrel 4 and the second zoom lens supporting barrel 5 to the wide angle side in the direction in which the first zoom lens supporting barrel 4 and the second zoom lens supporting barrel 5 move away from each other is explained.

The control unit 120 shown in FIG. 2 drives the motor 11a of the driving unit 11 and transmits power to the cam plate member 8 via the gear train 12. At this point, as shown in FIG. 1, the gear 12a on the cam plate member 8 side of the gear train 12 meshes with the teeth 8c provided in a part of the outer circumference of the cam plate member 8 and rotates the cam plate member 8 clockwise in front view of FIG. 1.

Consequently, as shown in FIG. 1, the first cam pin 6 and the second campin 7 that pierce through the campin pierce-through grooves 13c and 13d move away from the center through-hole 8d (the cam plate pivoting shaft pin 13a) along the first groove section 8a and the second groove section 8b that extend in the circumferential direction of the cam plate member 8. In this way, the first zoom lens supporting barrel 4 in which the first cam pin 6 is provided and the second zoom lens supporting barrel 5 in which the second cam pin 7 is provided move away from each other to the wide angle side.

Next, movement of the first zoom lens supporting barrel 4 and the second zoom lens supporting barrel 5 to the telescopic side in the direction in which the first zoom lens supporting barrel 4 and the second zoom lens supporting barrel 5 move close to each other is explained.

In this case, the motor 11a of the driving unit 11 and the gear train 12 rotate the cam plate member 8 counterclockwise in front view of FIG. 1.

Consequently, the first cam pin 6 and the second cam pin 7 move close to the center through-hole 8d (the cam plate pivoting shaft pin 13a) along the first groove section 8a and the second groove section 8b of the cam plate member 8. In this way, the first zoom lens supporting barrel 4 in which the first cam. pin 6 is provided and the second zoom lens supporting barrel 5 in which the second cam pin 7 is provided move close to each other to the telescopic side.

In the lens barrel 1 and the imaging device 100 according to this embodiment explained above, the cam plate member (an example of the moving member) 8 pivots to move the first zoom lens supporting barrel 4 and the second zoom lens supporting barrel 5 in the optical axis direction D1 of the first zoom lens supporting barrel 4 and the second zoom lens supporting barrel 5. The first cam pin (an example of the first projected section) 6 is provided in one of the first zoom lens supporting barrel 4 and the cam plate member 8 to cross the optical axis direction D1 and engages with the first groove section 8a provided in the other. The second cam pin (an example of the second projected section) 7 is provided in one of the second zoom lens supporting barrel 5 and the cam plate member 8 to cross the optical axis direction D1 and engages with the second groove section 8b provided in the other.

Therefore, since the cam plate member 8 assumes a plate shape (in this embodiment, a disc shape), it is possible to reduce the thickness of an arrangement space of the cam plate member 8 and reduce spaces around the prism 10a, the first zoom lens supporting barrel 4, the second zoom lens supporting barrel 5, and the like. Since the cam plate member 8 is pivoted, it is possible to set a large reduction gear ratio. Therefore, a large number of gears do not have to be arranged to reduce speed or a motor having large torque does not have to be used. It is also possible to reduce spaces of the gears and the motor.

Therefore, according to this embodiment, it is possible to provide the lens barrel 1 and the imaging device 100 that can realize a reduction in size.

In this embodiment, the first groove section 8a and the second groove section 8b are provided in the cam plate member 8, the first cam pin 6 is provided in the first zoom lens supporting barrel 4, and the second cam pin 7 is provided in the second zoom lens supporting barrel 5. Therefore, in this embodiment, it is possible to simplify a configuration for engaging the cam plate member 8, the first zoom lens supporting barrel 4, and the second zoom lens supporting barrel 5 and realize a further reduction in size.

In this embodiment, the lens barrel 1 and the imaging device 100 includes the imaging lens 9 located on the exit side in the optical axis direction D1 of the first zoom lens 2 and the second zoom lenses 3. Therefore, in this embodiment, it is possible to realize, with the configuration reduced in size as explained above, the zoom lens control on the incident side of the imaging lens 9.

In this embodiment, the prism (an example of the bending optical element) 10a is located on the incident side in the optical axis direction D1 of the first zoom lens 2 and the second zoom lenses 3 and bends incident light (the incident optical axis L2). Therefore, in this embodiment, it is possible to realize, with the configuration reduced in size as explained above, the zoom lens control in the lens barrel 1 and the imaging device 100 including the bent optical system 10. In this embodiment, the incident lens 10b is located on the incident side of the prism 10a and the cam plate member 8 is provided further in the incident side direction in the incident optical axis direction D2 of the incident lens 10b than the first zoom lens supporting barrel 4 and the second zoom lens supporting barrel 5. Therefore, in this embodiment, it is possible to effectively utilize spaces around the first zoom lens supporting barrel 4 and the second zoom lens supporting barrel 5 and realize a further reduction in size.

In this embodiment, the cam plate member 8 is provided in parallel to the optical axis direction D1 and in the position where the cam plate member 8 does not project further in the incident side direction of the incident optical axis direction D2 than the incident surface of the incident lens 10b. Therefore, it is possible to realize a further reduction in size.

In this embodiment, the motor 11a as at least a part of the driving unit 11 that pivots the cam plate member 8, which is an example of a moving member, is located on the back side of the reflection surface 10a-1 of the prism 10a. Therefore, in this embodiment, it is possible to effectively utilize a space generated by the bending optical element, an example of which is the prism 10a, and realize a further reduction in size.

In this embodiment, the bent optical system 10 including the prism 10a is arranged to be adjustable in position with respect to the fixed barrel 13. The gear train (an example of the power transmitting unit) 12 and the driving unit 11 are fixed to the fixed barrel 13. Therefore, in this embodiment, it is possible to prevent a positional shift that occurs when gears associated with each other are respectively provided on the bent optical system 10 side and the fixed barrel 13 side as in the past, i.e., a positional shift of the gear train 12 and the driving unit 11 due to the tilt adjustment of the prism 10a.

In this embodiment, in the cam plate member 8, which is a moving member, the teeth 8c are formed in the outer circumferential portion. The power of the driving unit 11 is transmitted by the gear train (an example of the power transmitting unit) 12 that meshes with the teeth 8c. Therefore, in this embodiment, it is possible to set a large reduction gear ratio and realize a further reduction in size.

In this embodiment, the power transmitting unit includes the gear train 12 (in this embodiment, includes only the gear train 12). Therefore, it is possible to realize a reduction in size with a simple configuration.

In this embodiment, the lens barrel 1 and the imaging device 100 include the bent optical system 10 to realize a reduction in size. However, even if the lens barrel 1 and the imaging device 100 do not include the bent optical system 10, it is possible to realize a reduction in size by using the cam plate member 8.

In this embodiment, the motor 11a as at least a part of the driving unit 11 is located on the back side of the reflection surface 10a-1 of the prism 10a. Therefore, it is possible to realize a further reduction in size. However, the driving unit 11 can also be arranged in other spaces.

### Another Embodiment

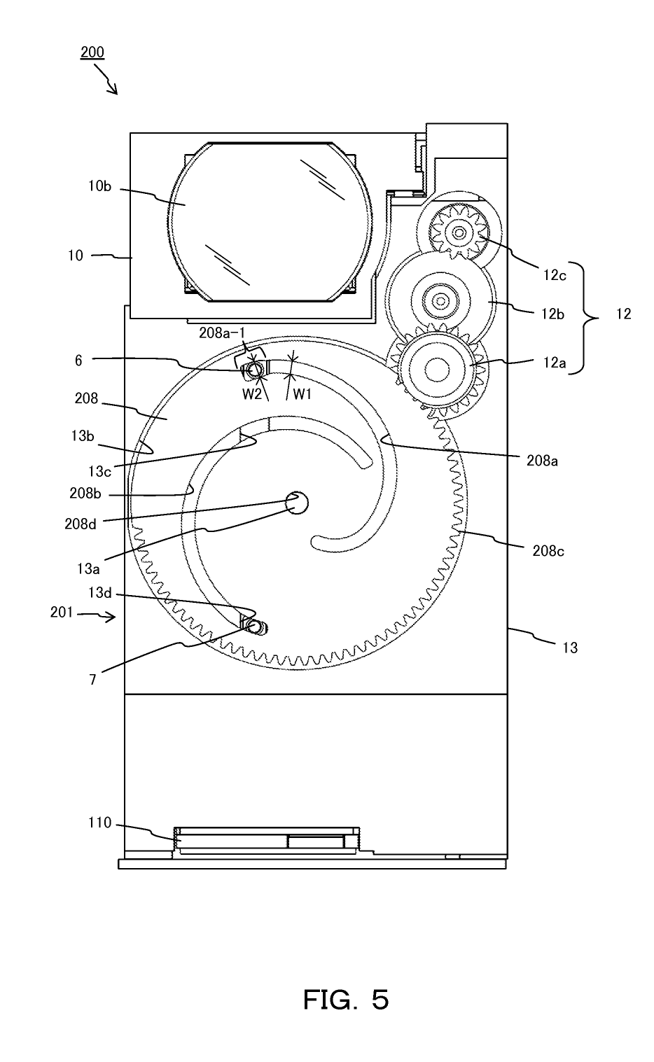

FIG. 5 is a front view showing a schematic configuration of an imaging device 200 according to another embodiment of the present invention.

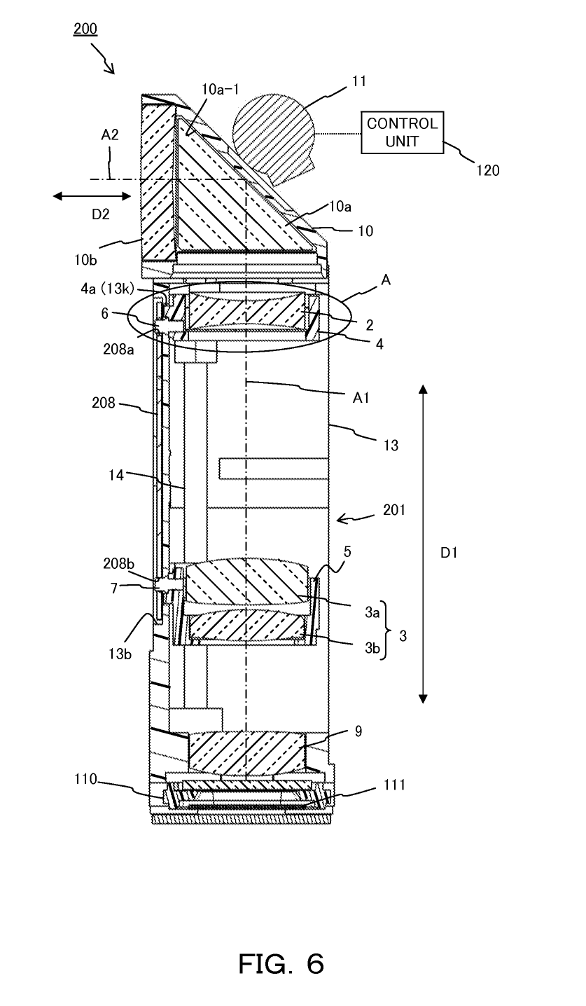

FIG. 6 is a sectional view showing a schematic configuration of the inside of the imaging device 200.

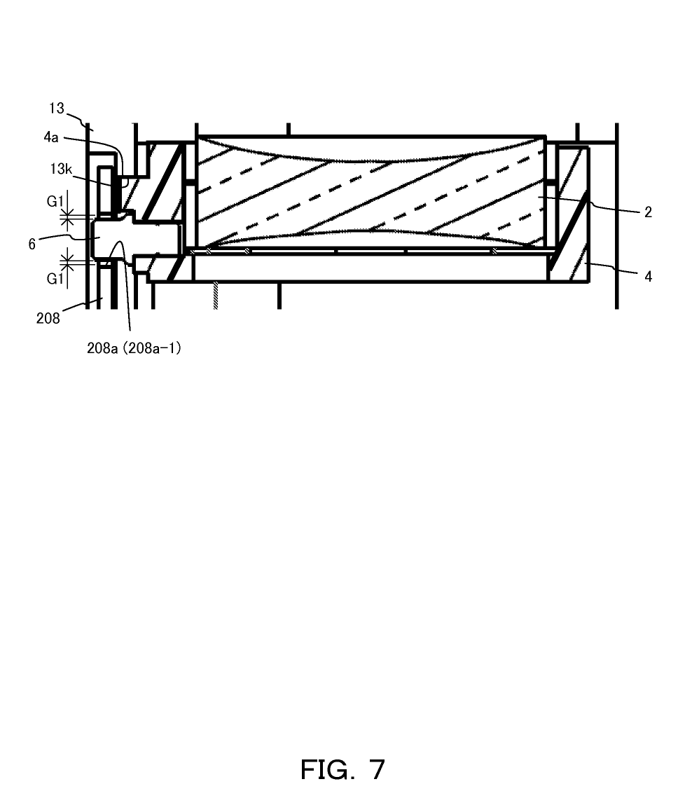

FIG. 7 is an enlarged view of an A part shown in FIG. 6.

As shown in FIGS. 5 and 6, the imaging device 200 includes a lens barrel 201, the image pickup device substrate 110 including the image pickup device 111 that receives exit light from this lens barrel 201 and outputs an imaging signal, and the control unit 120 that performs at least zoom lens control for the lens barrel 201. The imaging device 200 is disposed in, for example, an information terminal apparatus such as a cellular phone.

The lens barrel 201 includes the first zoom lens 2 and the second zoom. lenses 3 (3a and 3b), which are an example of plural zoom lenses, the first zoom lens supporting barrel 4 and the second zoom lens supporting barrel 5, which are an example of plural zoom lens supporting barrel, the first cam pin 6 and the second campin 7, which are an example of plural projected sections (cam pins), a cam plate member 208, which is an example of a moving member, the imaging lens 9, the bent optical system 10 including the prism (an example of a bending optical element) 10a and the incident lens 10b, the driving unit 11, the gear train 12 forming a power transmitting unit, the fixed barrel 13, and the guide shaft 14.

As shown in FIG. 6, the first zoom lens 2 is supported by the first zoom lens supporting barrel 4. In this embodiment, the two arranged second zoom lenses 3 (3a and 3b) are supported by the second zoom lens supporting barrel 5 and are located further on the exit side (a lower part in the figure) in the optical axis direction D1 than the first zoom lens 2.

As shown in FIG. 6, the first zoom lens supporting barrel 4 and the second zoom lens supporting barrel 5 are supported by the guide shaft 14, which extends in the optical axis direction D1 (the optical axis A1), to be movable independently from each other. Since this guide shaft 14 is fixed to the fixed barrel 13, it can be said that the first zoom lens supporting barrel 4 and the second zoom lens supporting barrel 5 are indirectly supported by the fixed barrel 13 to be movable. As in the case in which the guide shaft 14 is integrated with the fixed barrel 13, the first zoom lens supporting barrel 4 and the second zoom lens supporting barrel 5 may be directly supported by the fixed barrel 13. In the guide shaft 14, a not-shown compression spring (an example of an urging mechanism) that urges the first zoom lens supporting barrel 4 and the second zoom lens supporting barrel 5 in directions away from each other is provided.

As shown in FIGS. 5 and 6, the first cam pin 6 is provided in the first zoom lens supporting barrel 4 to be orthogonal to (or to cross) the optical axis direction D1. The second cam pin 7 is provided in the second zoom lens supporting barrel 5 to be orthogonal to (or to cross) the optical axis direction D1.

In this embodiment, the first cam pin 6 and the second cam pin 7 are members independent from the first zoom lens supporting barrel 4 and the second zoom lens supporting barrel 5 and fixed to the first zoom lens supporting barrel 4 and the second zoom lens supporting barrel 5. However, the first cam pin 6 and the second cam pin 7 maybe cam pins integrally formed with the first zoom lens supporting barrel 4 and the second zoom lens supporting barrel 5.

As shown in FIG. 5, the cam plate member 208 assumes a disc shape having teeth 208c that mesh with one gear 12a of the gear train 12 formed in the outer circumference thereof. A center through-hole 208d is formed in the center of the cam plate member 208. The cam plate member 208 is pivotably supported in the center through-hole 208d by a cam plate pivoting shaft pin 13a provided in the fixed barrel 13. This cam plate pivoting shaft pin 13a is orthogonal to (or crosses) the optical axis direction D1 and functions as a pivoting shaft of the cam plate member 208.

In this embodiment, since the cam plate member 208 does not pivot 360 degrees, the teeth 208c are formed only in a part of the outer circumference of the cam plate member 208 . The material of the cam plate member 208 is not specifically limited. However, the lens barrel 201 and the imaging device 200 can be thin by using a thin plate for the cam plate member 208. Therefore, in particular, when the cam plate member 208 is made thin, it is desirable to secure strength using metal from the viewpoint of drop resistance or the like of the imaging device 200.

In the cam plate member 208, a first groove section 208a that engages with the first cam pin 6 and a second groove section 208b that engages with the second cam pin 7 are formed in the circumferential direction of the cam plate member 208 to pierce through the cam plate member 208 in the thickness direction in this embodiment. The first groove section 208a and the second groove section 208b are formed independently from each other such that distances from the center through-hole 208d to the first groove section 208a and the second groove section 208b increase toward one side in the circumferential direction and decrease toward the other side in the circumferential direction.

Therefore, engaging positions of the first groove section 208a and the second groove section 208b with the first cam pin 6 and the second cam pin 7 change as the cam plate member 208 pivots. The first zoom lens supporting barrel 4 and the second zoom lens supporting barrel 5 in which the first cam pin 6 and the second cam pin 7 are provided to move close to or away in the optical axis direction D1.

The first cam pin 6 and the second cam pin 7 are inserted into the first groove section 208a and the second groove section 208b of the cam plate member 208 piercing through the cam pin pierce-through grooves 13c and 13d provided in the fixed barrel 13 and extending in the optical axis direction D1.

In this embodiment, when the cam plate member 208 rotates clockwise in front view of FIG. 5, as shown in FIG. 5, the first cam pin 6 and the second cam pin 7 move away from the center through-hole 208d (the cam plate pivoting shaft pin 13a) along the first groove section 208a and the second groove section 208b. The first zoom lens supporting barrel 4 and the second zoom lens supporting barrel 5 move to a wide angle side.

On the other hand, when the cam plate member 208 rotates counterclockwise in front view of FIG. 5, the first cam pin 6 and the second cam pin 7 move close to the center through-hole 208d (the cam plate pivoting shaft pin 13a) along the first groove section 208a and the second groove section 208b. The first zoom lens supporting barrel 4 and the second zoom lens supporting barrel 5 move to a telescopic side.

When the first zoom lens supporting barrel 4 and the second zoom lens supporting barrel 5 move to the end on the wide angle side as shown in FIGS. 5 and 6, as shown in FIG. 7, which is the enlarged view of the A section shown in FIG. 6, the first zoom lens supporting barrel 4 comes into contact with a plane section (an example of a portion to be contacted) 13k of the fixed barrel 13 in a plane section (an example of a contacting portion) 4a.

In this embodiment, the plane section 4a of the first zoom lens supporting barrel 4 is provided in a part of an upper surface (a surface on the incident side in the optical axis direction D1) of the peripheral edge of the first zoom lens supporting barrel 4 to be orthogonal to the optical axis direction D1. In this embodiment, the plane section 13k of the fixed barrel 13 is provided on the inner side of the cam plate housing recess 13b, which houses the cam plate member 208, to be orthogonal to the optical axis direction D1 to be opposed to the plane section 4a of the first zoom lens supporting barrel 4. The first groove section 208a is formed in length having a margin on the wide angle side in the circumferential direction (208a-1 side) not to come into contact with the first cam pin 6 when the plane sections 4a and 13k are in a contact state in which the plane sections 4a and 13k come into contact with each other (a state shown in FIGS. 5 and 6) . Therefore, the plane sections 4a and 13k come into contact with each other before the first cam pin 6 reaches the end of the first groove section 208a.

As shown in FIG. 5, the first groove section 208a further expands by length G1 in each of both sides in the width direction in a portion 208a-1 at predetermined length from the end on the wide angle side, which is a portion into which the first cam pin 6 is inserted when the plane sections 4a and 13k are in a contact state, than in other portions. The width W2 of the portion 208a-1 is larger than the width W1 of the other portions (W2=W1+2×G1) .

Therefore, as shown in FIG. 7, even if the plane sections 4a and 13k come into contact with each other, the first cam pin 6 and the first groove section 208a do not come into contact with each other not only in the circumferential direction of the first groove section 208a but also in the width direction. Gaps G1 are formed on both the sides in the width direction. Therefore, even if external force is applied to the lens barrel 201 (the imaging device 200) because of a drop or the like, force is not applied from the cam plate member 208 to the first cam pin 6.

As shown in FIG. 6, the imaging lens 9 is located further on the exit side in the optical axis direction D1 than the first zoom lens 2 and the second zoom lenses 3 (3a and 3b) . Specifically, the imaging lens 9 is located at the lower end of the lens barrel 201 and supported by the fixed barrel 13.

The prism 10a of the bent optical system 10 is located further on the incident side in the optical axis direction D1 than the first zoom lens 2 and the second zoom lenses 3 (3a and 3b) and bends incident light (the incident optical axis A2) at a right angle.

The incident lens 10b is located on the incident side in the incident optical axis direction D2 of the prism 10a.

As shown in FIGS. 5 and 6, the cam plate member 208 is housed in a cam plate housing recess 13b of the fixed barrel 13 from the outer side. As shown in FIG. 6, the cam plate member 208 is provided further in an incident side direction (the left side in the figure) in the incident optical axis direction D2 of the incident lens 10b than the first zoom lens supporting barrel 4 and the second zoom lens supporting barrel 5.

The incident lens 10b projects to the incident side in the incident optical axis direction D2 from the fixed barrel 13. The cam plate member 208 is provided such that the cam plate pivoting shaft pin 13a serving as the pivoting center is orthogonal to the optical axis direction D1 as explained above.

The cam plate member 208 is arranged in parallel to the optical axis direction D1. The cam plate member 208 is provided in a position where the cam plate member 208 does not project further in the incident side direction of the incident optical axis direction D2 than the incident surface of the incident lens 10b.

At least a part of the driving unit 11 is located on the back side of the reflection surface 10a-1 of the prism 10a . The driving unit 11 pivots the gear train 12 shown in FIG. 5 (rotates the gear train 12 in both the directions). The power of the driving unit 11 is transmitted to the cam plate member 208 by the gear train 12 including the plural gears 12c, 12b, and 12a. The gears 12c, 12b, and 12a of the gear train 12 are pivotably engaged with the fixed barrel 13. The gear 12a on the cam plate member 208 side meshes with the teeth 208c of the cam plate member 208 and pivots the cam plate member 208.

The control unit 120 shown in FIG. 6 performs driving control for the driving unit 11 to control the movement of the first zoom lens supporting barrel 4 and the second zoom lens supporting barrel 5, i.e., the zoom lens control. The control unit 120 may perform other control such as processing of an imaging signal output from the image pickup device 111 other than the zoom lens control for the lens barrel 201.

The image pickup device substrate 110 is fixed to, for example, the bottom plate of the fixed barrel 13 on the exit side in the optical axis direction L1 of the imaging lens 9. The image pickup device 111 of the image pickup device substrate 110 receives exit light from the lens barrel 201, i.e. , exit light from the imaging lens 9 and outputs an imaging signal. This imaging signal is sent to, for example, the control unit 120 shown in FIG. 6.

The zoom lens control performed using the imaging device 200 is explained. However, redundant explanation is omitted as appropriate.

First, the movement of the first zoom lens supporting barrel 4 and the second zoom lens supporting barrel 5 to the wide angle side in the direction in which the first zoom lens supporting barrel 4 and the second zoom lens supporting barrel 5 move away from each other is explained.

The control unit 120 shown in FIG. 6 drives the driving unit 11 and transmits power to the cam plate member 208 via the gear train 12. At this point, as shown in FIG. 5, the gear 12a on the cam plate member 208 side of the gear train 12 meshes with the teeth 208c provided in a part of the outer circumference of the cam plate member 208 and rotates the cam plate member 208 clockwise in front view of FIG. 5.

Consequently, as shown in FIG. 5, the first cam pin 6 and the second campin 7 that pierce through the campin pierce-through grooves 13c and 13d move away from the center through-hole 208d (the cam plate pivoting shaft pin 13a) along the first groove section 208a and the second groove section 208b that extend in the circumferential direction of the cam plate member 208. In this way, the first zoom lens supporting barrel 4 in which the first cam pin 6 is provided and the second zoom lens supporting barrel 5 in which the second cam pin 7 is provided move away from each other to the wide angle side.

As explained above, the first zoom lens supporting barrel 4 comes into contact with the plane section 13k of the fixed barrel 13 in the plane section 4a.

On the other hand, as explained above, the first groove section 208a is formed in length having a margin in the circumferential direction not to come into contact with the first cam pin 6 when the plane sections 4a and 13k are in the contact state in which the plane sections 4a and 13k come into contact with each other. Therefore, the plane sections 4a and 13k come into contact with each other before the first cam pin 6 reaches the end of the first groove section 208a.

As explained above, the first groove section 208a further expands by length G1 in each of both the sides in the width direction in the portion 208a-1 at the predetermined length from the end on the wide angle side, which is the portion into which the first cam pin 6 is inserted when the plane sections 4a and 13k are in the contact state, than in other portions . The width W2 of the portion 208a-1 is larger than the width W1 of the other portions (W2=W1+2×G1).

Therefore, as shown in FIG. 7, even if the plane sections 4a and 13k come into contact with each other, the first cam pin 6 and the first groove section 208a do not come into contact with each other not only in the circumferential direction of the first groove section 208a but also in the width direction. The gaps G1 are formed in the width direction. Therefore, even if external force is applied to the lens barrel 201 (the imaging device 200) because of a drop or the like, force is not applied from the cam plate member 208 to the first cam pin 6.

The second groove section 208b is desirably also formed in length having a margin in the circumferential direction and in large width such that the second cam pin 7 does not come into contact with the end of the second groove section 208b.

Next, movement of the first zoom lens supporting barrel 4 and the second zoom lens supporting barrel 5 to the telescopic side in the direction in which the first zoom lens supporting barrel 4 and the second zoom lens supporting barrel 5 move close to each other is explained.

In this case, the motor 11a of the driving unit 11 and the gear train 12 rotate the cam plate member 208 counterclockwise in front view of FIG. 5.

Consequently, the first cam pin 6 and the second cam pin 7 move close to the center through-hole 208d (the cam plate pivoting shaft pin 13a) along the first groove section 208a and the second groove section 208b of the cam plate member 208. In this way, the first zoom lens supporting barrel 4 in which the first cam pin 6 is provided and the second zoom lens supporting barrel 5 in which the second cam pin 7 is provided move close to each other to the telescopic side.

In this embodiment, the first zoom lens supporting barrel 4 and the second zoom lens supporting barrel 5 are urged by the compression spring (the urging mechanism) provided in the guide shaft 14 to the wide angle side in the direction in which the first zoom lens supporting barrel 4 and the second zoom lens supporting barrel 5 move away from each other. Therefore, in this embodiment, on the telescopic side, the contacting portion and the portion to be contacted are not provided in the fixed barrel 13 and the first and second zoom lens supporting barrels 4 and 5. However, the contacting portion and the portion to be contacted may be provided on the telescopic side as well. When an urging direction of the urging mechanism is the telescopic side, the contacting portion and the portion to be contacted may be provided only on the telescopic side.

In the lens barrel 201 and the imaging device 200 according to the embodiment explained above, the plane section 4a functioning as the contacting portion is provided in at least the first zoom lens supporting barrel 4, which is one of the plural zoom lens supporting barrels 4 and 5. The plane section 13k functioning as the portion to be contacted is provided in the fixed barrel 13 that movably supports the plural zoom lens supporting barrels 4 and 5. These plane sections 4a and 13k come into contact with each other when the first zoom lens supporting barrel 4 moves to the end on the wide angle side (or the end on the telescopic side).

Therefore, even if external force is applied to the lens barrel 201 (the imaging device 200) because of a drop or the like, the force can be received by the plane sections 4a and 13k. It is possible to prevent the first cam pin 6 from coming off or prevent a dent from occurring in the first groove section 208a. Further, since other members such as a separate cam pin for drop prevention do not have to be used, it is possible to suppress cost from being increased because of, for example, an increase in the number of components.

Therefore, according to this embodiment, it is possible to provide the lens barrel 201 and the imaging device 200 that can suppress force from being applied to the cam pin (the first cam pin 6) and prevent an increase in cost.

In this embodiment, the plane sections 4a and 13k come into contact with each other before the first cam pin 6 reaches the end of the first groove section 208a. Therefore, it is possible to suppress force from being applied to the cam pin (the first cam pin 6) .

In this embodiment, in the first groove section 208a (at least one of the plural groove sections) , the width W2 of the portion 208a-1 into which the first cam pin 6 is inserted when the plane sections 4a and 13k are in the contact state is larger than the width W1 of the portion into which the first cam pin is inserted when the plane sections 4a and 13k are not in the contact state. Therefore, it is possible to suppress force from being applied to the cam pin (the first cam pin 6) in the width direction of the groove section (the first groove section 208a).

In this embodiment, the plural cam pins 6 and 7 are provided respectively in the first zoom lens supporting barrel 4 and the second zoom lens supporting barrel 5 to cross the optical axis direction D1 . The cam plate member 208 pivots to move the first zoom lens supporting barrel 4 and the second zoom lens supporting barrel 5 in the optical axis direction D1 of the first zoom lens supporting barrel 4 and the second zoom lens supporting barrel 5. Therefore, since the cam plate member 208 assumes a plate shape (in this embodiment, a disc shape), it is possible to reduce the thickness of an arrangement space of the cam plate member 208 and reduce spaces around the prism 10a, the first zoom lens supporting barrel 4, the second zoom lens supporting barrel 5, and the like. Since the cam plate member 208 is pivoted, it is possible to set a large reduction gear ratio. A large number of gears do not have to be arranged to reduce speed or a motor having large torque does not have to be used. It is also possible to reduce spaces of the gears and the motor. Therefore, it is possible to realize a reduction in size of the lens barrel 201 and the imaging device 200.

In this embodiment, the prism 10a as the bending optical element is located on the incident side in the optical axis direction D1 of the first zoom lens 2 and the second zoom lenses 3 (3a and 3b) and bends incident light (the incident optical axis L2) . Therefore, the lens barrel 201 and the imaging device 200 including the bent optical system 10 can perform the zoom lens control with the configuration reduced in size as explained above.

In this embodiment, the incident lens 10b is located on the incident side of the prism 10a and the cam plate member 208 is provided further in the incident side direction in the incident optical axis direction D2 of the incident lens 10b than the first zoom lens supporting barrel 4 and the second zoom lens supporting barrel 5. Therefore, it is possible to effectively utilize spaces around the first zoom lens supporting barrel 4 and the second zoom lens supporting barrel 5 and realize a further reduction in size.

In this embodiment, the cam plate member 208 is provided in parallel to the optical axis direction D1 and in the position where the cam plate member 208 does not project further in the incident side direction of the incident optical axis direction D2 than the incident surface of the incident lens 10b. Therefore, it is possible to realize a further reduction in size.

In this embodiment, at least a part of the driving unit 11 that pivots the cam plate member 208 is located on the back side of the reflection surface 10a-1 of the prism 10a. Therefore, it is possible to effectively utilize a space generated by the bending optical element, an example of which is the prism 10a, and realize a further reduction in size.

In this embodiment, in the cam plate member 208, the teeth 208c are formed in the outer circumferential portion. The power of the driving unit 11 is transmitted by the gear train (an example of the power transmitting unit) 12 that meshes with the teeth 208c. Therefore, in this embodiment, it is possible to set a large reduction gear ratio and realize a further reduction in size.

In this embodiment, the power transmitting unit includes the gear train 12 (in this embodiment, includes only the gear train 12). Therefore, it is possible to realize a reduction in size with a simple configuration.

In this embodiment, the example in which the plane section 4a, which is an example of the contacting portion, is provided only in the first zoom lens supporting barrel 4 is explained. However, the contacting portion may be provided only in the second zoom lens supporting barrel 5 or may be provided in both the first zoom lens supporting barrel 4 and the second zoom lens supporting barrel 5.

In this embodiment, only in the first groove section 208a, the width of the portion 208a-1 into which the first cam pin 6 is inserted in the contact state is set larger than the width W1 of the other portions. However, the width may be set larger in this way only in the second groove section 208b or may be in both the first groove section 208a and the second groove section 208b.

In this embodiment, the plane section 4a of the first zoom lens supporting barrel 4 as the contacting portion is provided in a part of the upper surface of the peripheral edge of the first zoom lens supporting barrel 4 to be orthogonal to the optical axis direction D1. The plane section 13k of the fixed barrel 13 as the portion to be contacted is provided on the inner side of the cam plate housing recess 13b, which houses the cam plate member 208, to be orthogonal to the optical axis direction D1 to be opposed to the plane section 4a of the first zoom lens supporting barrel 4. However, the positions, the sizes, the directions, and the like of the contacting portion and the portion to be contacted can be changed as appropriate.

In this embodiment, the plane section (the contacting portion) 4a and the plane section (the portion to be contacted) 13k come into contact with each other before the first cam pin 6 reaches the end of the first groove section 208a. Therefore, it is possible to suppress force from being applied to the first cam pin 6. However, when the first cam pin 6 comes into contact with the first groove section 208a simultaneously with the plane sections 4a and 13k coming into contact with each other, it is also possible to considerably suppress force from being applied to the first cam pin 6.

In this embodiment, in the first groove section 208a, the width W2 of the portion 208a-1 into which the first cam pin 6 is inserted when the plane sections 4a and 13k are in the contact state is larger than the width W1 of the portion into which the first cam pin 6 is inserted when the plane sections 4a and 13k are not in the contact state. Therefore, it is possible to suppress force from being applied to the first cam pin 6 in the width direction of the first groove section 208a. In this embodiment, even if the width of the first groove section 208a is fixed, it is possible to suppress force from being applied to the first cam pin 6 in the circumferential direction of the first groove section 208a in which force is most likely to be applied. Therefore, the width of the first groove section 208a may be fixed.

In this embodiment, since the cam plate member 208 having the plate shape is used as an example of the cam member . Therefore, it is possible to realize a reduction in size as explained above. However, from the viewpoint of suppressing force from being applied to the first cam pin 6, which is an example of the cam pin, the cam member may assume a shaft shape or other shapes.

The lens barrel 201 and the imaging device 200 may be a lens barrel and an imaging device not including the bent optical system 10 or may be a lens barrel and an imaging device in which at least a part of the driving unit 11 is not located on the back side of the reflection surface 10a-1 of the prism 10a.

### Yet Another Embodiment

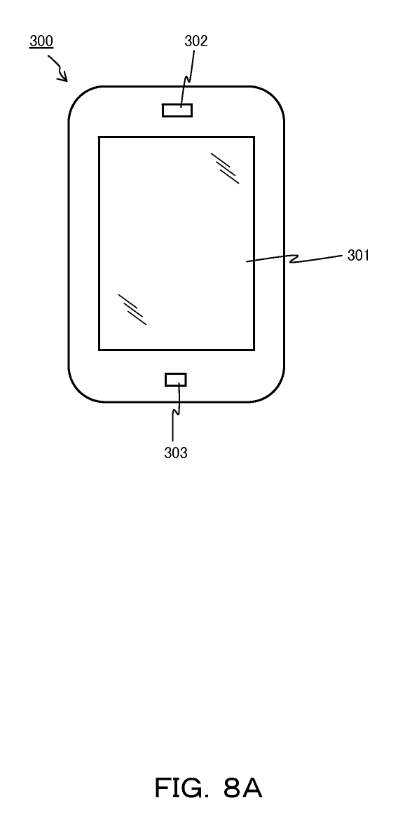

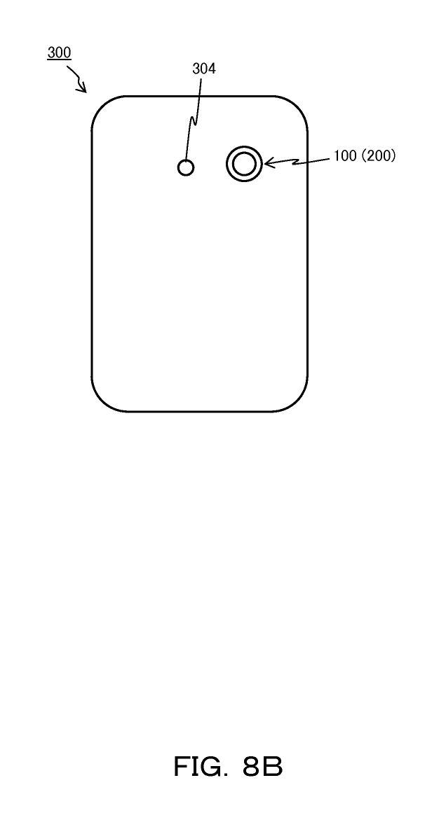

FIGS. 8A and 8B are a front view and a rear view showing an information terminal according to yet another embodiment of the present invention.

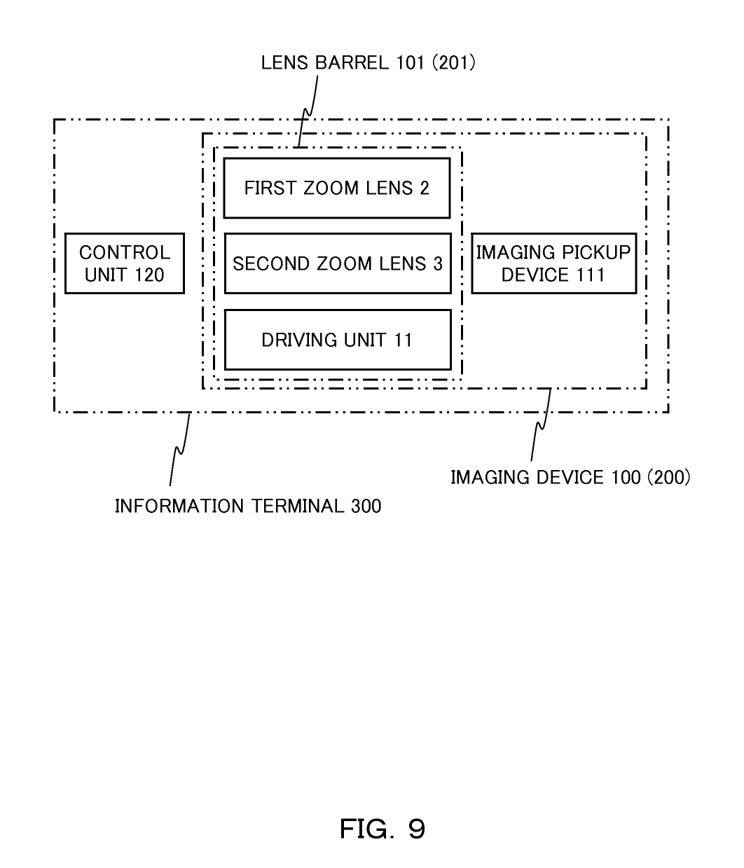

FIG. 9 is a schematic block diagram showing a control configuration of an information terminal.

As shown in FIGS. 8A and 8B, an information terminal 300 includes the imaging devices 100 and 200, the control unit 120 (see FIGS. 2 and 6) , a display unit 301, a speaker 302, a microphone 303, and an illuminating unit 304. Examples of the information terminal 300 include a cellular phone with camera and a tablet. However, the information terminal 300 is not limited to these devices.

The control unit 120 controls units of the lens barrels 101 and 201, such as a driving unit 110 for moving the first zoom lens 2 and the second zoom lens 3 and the image pickup device 111. When the control unit 120 controls the image pickup device 111, the control unit 120 causes the image pickup device 111 to perform imaging under predetermined conditions on the basis of a signal or the like input from the outside.

The display unit 301 also serves as an input unit of a touch panel type and can input a signal to the control unit 120.

The speaker 302 and the microphone 303 are arranged across the display unit 301 and include a function of a telephone.

The illuminating unit 304 irradiates illumination light on an imaging target to enable the imaging devices 100 and 200 to image the imaging target even in the dark.

Besides, the present invention is not limited to the embodiments and various improvements and modifications of the present invention are possible without departing from the spirit of the present invention.

What is claimed is:

1. A lens barrel comprising:
a first zoom lens;
a second zoom lens;
a first zoom lens supporting barrel that supports the first zoom lens;
a second zoom lens supporting barrel that supports the second zoom lens;
a moving member that moves the first zoom lens supporting barrel and the second zoom lens supporting barrel in an optical axis direction of the first and second zoom lens supporting barrels;
a first projected section that is provided in one of the first zoom lens supporting barrel and the moving member to cross the optical axis direction and engages with a first groove section provided in the other; and
a second projected section that is provided in one of the second zoom lens supporting barrel and the moving member to cross the optical axis direction and engages with a second groove section provided in the other.

2. The lens barrel according to claim 1, wherein the moving member is a cam plate member that pivots to move the first zoom lens supporting barrel and the second zoom lens supporting barrel in the optical axis direction thereof.

3. The lens barrel according to claim 1, wherein
the first groove section and the second groove section are provided in the plate member,
the first projected section is provided in the first zoom lens supporting barrel; and
the second projected section is provided in the second zoom lens supporting barrel.

4. The lens barrel according to claim 1, further comprising an imaging lens located on an exit side in the optical axis direction of the first zoom lens and the second zoom lens.

5. The lens barrel according to claim 1, further comprising a bending optical element that is located on an incident side in the optical axis direction of the first zoom lens and the second zoom lens and bends incident light.

6. The lens barrel according to claim 5, further comprising an incident lens located on an incident side in an incident optical axis direction of the bending optical element, wherein
the moving member is a cam plate member, and
the cam plate member is provided further in an incident side direction of the incident lens than the first zoom lens supporting barrel and the second zoom lens supporting barrel.

7. The lens barrel according to claim 6, wherein the cam plate member is provided in parallel to the optical axis direction and in a position where the cam plate member does not project further in the incident side direction in the incident optical axis direction than an incident surface of the incident lens.

8. The lens barrel according to claim 5, wherein
the moving member is a cam plate member, and
the lens barrel further comprises a driving unit located at least in part on a back side of a reflection surface of the bending optical element, the driving unit pivoting the cam plate member.

9. The lens barrel according to claim 8, further comprising:
a power transmitting unit that transmits power of the driving unit to the cam plate member; and
a barrel that movably supports the first zoom lens supporting barrel and the second zoom lens supporting barrel, wherein
the bending optical element is arranged to be adjustable in position with respect to the fixed barrel, and
the power transmitting unit and the driving unit are fixed to the fixed barrel.

10. The lens barrel according to claim 9, wherein teeth are formed in an outer circumferential portion of the cam plate member, and the power of the driving unit is transmitted by the power transmitting unit that meshes with the teeth.

11. The lens barrel according to claim 9, wherein the power transmitting unit includes a gear train.

12. The lens barrel according to claim 2, further comprising:
a fixed barrel that movably supports the first and second zoom lens supporting barrels;
a contacting portion provided in at least one of the first and second zoom lens supporting barrels; and
a portion to be contacted that is provided in the fixed barrel and comes into contact with, when the first or second zoom lens supporting barrels moves to an end on a wide angle side or an end on a telescopic side, the contacting portion of the zoom lens supporting barrel.

13. The lens barrel according to claim 12, wherein the contacting portion and the portion to be contacted come into contact with each other before the projected sections reach ends of the groove sections.

14. The lens barrel according to claim 12, wherein, in at least one of the first and second groove sections, width of a portion into which the projected section is inserted when the contacting portion and the portion to be contacted are in a contact state is larger than width of a portion into which the projected section is inserted when the contacting portion and the portion to be contacted are not in the contact state.

15. The lens barrel according to claim 1, wherein the first and second projected sections are cam pins.

16. An imaging device comprising:
the lens barrel according to claim 1;
an image pickup device that receives exit light from the lens barrel and outputs an imaging signal; and
a control unit that performs at least zoom lens control for the lens barrel.

17. An information terminal comprising:
the imaging device according to claim 16; and
a control unit that controls the imaging device.
